(19) United States
(12) Patent Application Publication
(10) Pub. No.: US 2020/0179787 A1
(43) Pub. Date: Jun. 11, 2020

(54) Heads-Up Display For Eyewear

(71) Applicant: SWIMAR LTD, Chiswick (GB)

(72) Inventors: Julian Francis Ralph Swan, Ealing (GB); Adrian Mark Hester, Acton (GB)

(21) Appl. No.: 16/346,246

(22) PCT Filed: Nov. 2, 2017
(86) PCT No.: PCT/GB2017/000161

§ 371 Date: Apr. 30, 2019

(30) Foreign Application Priority Data
Nov. 2, 2016 (GB) 1618513.4

(51) Int. Cl. A63B 71/06; G02B 27/01; G06F 3/01; G09G 5/37; A63B 33/00

(52) U.S. Cl. CPC A63B 71/0622; A63B 2220/62; G02B 27/0176; G06F 3/011; G09G 5/37; A63B 33/002; G02B 2027/0178; G02B 2027/014; G02B 2027/0174; G02B 2027/0138; G02B 2027/0143; G09G 2354/00; A63B 2220/30; A63B 2220/40; A63B 2220/56; A63B 2220/836; A63B 2230/06; A63B 2071/0666; A63B 2220/806; G02B 27/0172

(57) ABSTRACT

A heads-up display for an item of eyewear includes a mounting means configured to mount the heads-up display to the item of eyewear; at least one sensor configured to obtain performance data; a processing unit operatively connected to the at least one sensor, and configured to process said performance data and to generate an image from said performance data; a micro display unit operatively connected to the processing unit, and configured to display the image under the control of the processing unit; and, an optical wave guide in optical communication with the micro display unit, and configured to route the image from the micro display into a field of view of a wearer of the item of eyewear. The heads-up display is configured to overlay the image into the line of sight of the wearer, such that the wearer can view their surrounding environment at the same time as the image, and therefore view their performance data real-time.

### CROSS-REFERENCE TO RELATED APPLICATIONS

This is the U.S. National Stage application of International Application No. PCT/GB2017/000161, filed Nov. 2, 2017, which claims the benefit of priority from GB Application No. 1618513.4, filed Nov. 2, 2016. These prior applications are incorporated by reference in their entirety.

### FIELD

This invention pertains generally to the field of Heads-Up Displays for eyewear, and in particular means of displaying performance data to a wearer of said eyewear through Heads-Up Display means.

### BACKGROUND

Heads-Up Displays, or HUDs, typically comprise a transparent display that presents imagery to a wearer without requiring them to look away from their usual viewpoints. These HUDs allow a wearer to view their surrounding environment at the same time as the presented imagery on the display without the need to refocus their eyes, and within their field of vision. Some HUDs incorporate head mounting means to allow the transparent display to move with the head movements of a wearer.

There is a rising trend to track athletic performance and activity, with widespread use of wristworn activity trackers, and other devices such as those that utilise a smartphone or tablet to obtain performance data and allow an individual to keep track of various performance data during a particular sporting venture. However, wristworn activity trackers are not designed to be suitable for all environment. For real-time tracking of performance data, they typically require that an individual raise their arm to view the screen whilst carrying out a specific activity. Or alternatively, they do not offer a real-time option, requiring that the individual download their data after the specific activity, and assess their performance at a later time.

In a number of situations, to help a person to improve or track specific performance data parameters, real-time delivery of such data offers considerable advantages. For an example, when monitoring a person's heart rate to ensure that they keep within a predetermined set of values, or when tracking their pace to ensure that they are on track to complete an activity in a required amount of time.

An individual and/or their coaching team may wish to track performance data such as time, speed, power, distance, heart rate, calories, stroke rate, elapsed time, lap time. They may also wish to be provided with training instructions and/or feedback, tactical information, route and directional information, competitor information, and other data specific to a certain sporting activity or event.

The swimming environment in particular is one example of sporting endeavour that does not lend itself well to wristworn activity monitoring. Current state of art for swim training requires a user to wear a wrist worn data gathering watch. These watches can typically record elapsed time, swimming pool laps, stroke rate, heart rate and distance covered; which are typically designed to be referred to post swim, poolside or by downloading the data onto another device. For those wristworn devices that can be used in water, and do provide real-time displays of performance data, they require that the swimmer alter their stroke to be able to view the watch face, which would be detrimental to their performance.

For professional swimmers, where milliseconds count, any additional bodyworn elements may also cause drag in the water, thus affecting performance. Equipment for use in such a competitive environment must fit the individual and be streamlined so as to have a marginal, if any, effect on their performance. Retrofittable training devices that are designed to fit with their existing equipment are typically preferred. For an example, training devices that can be retrofitted to a swimmer's existing or own choice of goggles, or triathlete's existing or own choice of eyewear.

Swimmer's frequently replace their goggles. The seals can become worn and leak. The elastic straps and nose pieces can break. The goggles can become scratched or the plastic degrade such that it impairs their view. Typically, a professional swimmer would replace their goggles a number of times a year, or keep a number of spare pairs readily available.

The performance data that is currently available to a swimmer, through wristworn devices, is rather limited. An athlete and/or coach may also be interested to see data such as instantaneous swim pace, a live comparison with previous swimming sessions, or even a means to race against virtual swimmers to create a virtual race environment and even a means to race against swimmers located in other swimming pools, yet at the same time. For those taking part in open water swimming events, navigation data may also be of use to ensure the correct path is taken. Existing systems only go some way to providing such a virtual coaching environment. Further enhancements may include information about other competitor's performance, such as distance, speed, which would aid in competition tactics.

The prior art shows a number of devices that attempt to address these needs in various ways.

US 2014,213,917 (Butterfleye) discloses a waterproof heart rate measuring apparatus that provides a retrofittable, demountable device suitable for mounting to many different goggle styles and types. It comprises a series of light-emitting diodes around the lower edge of the goggle to indicate heart-rate by pulsing, or using a traffic light system, to indicate if the athlete is in their target zone. Whilst providing a retrofittable device that delivers real-time performance data to the athlete's line of vision, the data available is extremely limited, and the device requires pre-programming to determine an individual's target zone.

U.S. Pat. No. 5,685,722 (US Divers Co Inc) discloses electronic timing swimmer's goggles. These goggles comprise a standard segmented LCD/LED display system that through a series of lenses are configured to display time and number of laps to a wearer in real-time. This display system is again limited in the data that it can supply to the swimmer during their swim, and the display screen itself is likely to affect their performance by impairing their view of their surrounding environment.

Whilst the prior art appears to address the issue of obtaining and displaying some key performance data, real-time, through low-tech interfaces, to an athlete during their event, they do not provide a means of supplying a wide range of performance data, navigational data, coaching data and feedback. They also do not deliver this information to a wearer in such a way that does not impair their field of view, and therefore their performance.

### BRIEF SUMMARY

Preferred embodiments of the present invention aim to provide a means of displaying real-time data and/or imagery to an athlete, to include performance data, navigational information, coaching input, virtual gaming, during their sporting activity, without obscuring their field of view, and with limited, if any, effect to their hydrodynamics, and therefore their performance.

According to one aspect of the present invention, there is provided a heads-up display for an item of eyewear, the heads-up display comprising: a mounting means configured to mount the heads-up display to the item of eyewear; at least one sensor configured to obtain performance data; a processing unit operatively connected to the at least one sensor, and configured to process said performance data and to generate an image from said performance data; a micro display unit operatively connected to the processing unit, and configured to display the image under the control of the processing unit; and, an optical wave guide in optical communication with the micro display unit, and configured to route the image from the micro display into a field of view of a wearer of the item of eyewear, whereby, in use, the heads-up display is configured to overlay the image into the line of sight of the wearer, such that the wearer can view their surrounding environment at the same time as the image, and therefore view their performance data in real-time.

Preferably, the optical wave guide is configured to route the image onto a holographic display.

Preferably, the holographic display incorporates at least one holographic coupling element configured to couple the image within the waveguide.

The optical wave guide may incorporate at least one hologram.

The at least one sensor may comprise one or more of the following: accelerometer, pressure sensor, heart rate sensor, speed sensor.

The performance data may comprise one or more of the following: time, speed, power, pace, heart rate, distance, acceleration, flow.

The processing unit may incorporate control means comprising one or more of the following: on/off button, mode selection.

Preferably, the mounting means comprises a plurality of O-rings.

The heads-up display may comprise a collimator lens configured to collimate the image, and mounted between the micro display unit and the optical wave guide.

Preferably, the processing unit incorporates a transceiver to transmit and receive the performance data to and/or from a computer and/or smartphone and/or tablet device and/or video camera.
The transceiver may comprise a Bluetooth™ module.
The processing unit may incorporate a GPS module.
The processing unit may incorporate a timing means.
The heads-up display may incorporate a video camera.
The processing unit may comprise a charging port, operatively connected to a rechargeable battery.
Alternatively, a contactless charging case may be configured to charge the heads-up display through wireless means.
According to a further aspect of the present invention, an item of eyewear may incorporate the heads-up display as hereinbefore described.
According to yet a further aspect of the present invention, a pair of swimming goggles may incorporate the heads-up display as hereinbefore described.

### BRIEF DESCRIPTION OF THE DRAWINGS

For a better understanding of the invention and to show how embodiments of the same may be carried into effect, reference will now be made, by way of example, to the accompanying diagrammatic drawings, in which:

FIG. 1 shows one embodiment of Heads-Up Display in isometric view, showing the holographic display and one embodiment of mounting means;

FIG. 2 shows the Heads-Up Display of FIG. 1 in plan view, showing a configuration of mounting means;

FIG. 3 shows the Heads-Up Display of FIG. 1 in underside view, showing the control means and one arrangement of gripping means;

FIG. 4 shows a side view of the Heads-Up Display of FIG. 1;

FIG. 5 shows a further isometric view of the Heads-Up Display of FIG. 1;

FIG. 6 shows a plan view of the Heads-Up Display when mounted to a pair of swimming goggles;

FIG. 7 shows an isometric view of the Heads-Up Display when mounted to a pair of swimming goggles of FIG. 6, showing the arrangement when worn on a wearer's head;

FIG. 8 shows the Heads-Up Display when housed within one embodiment of charging case;

FIG. 9 shows a flow chart of one embodiment of Heads-Up Display, from obtaining data to displaying an image of said data to a wearer; and,

FIG. 10 shows a diagrammatic view of one embodiment of layout of image handling components.

In the figures like references denote like or corresponding parts.

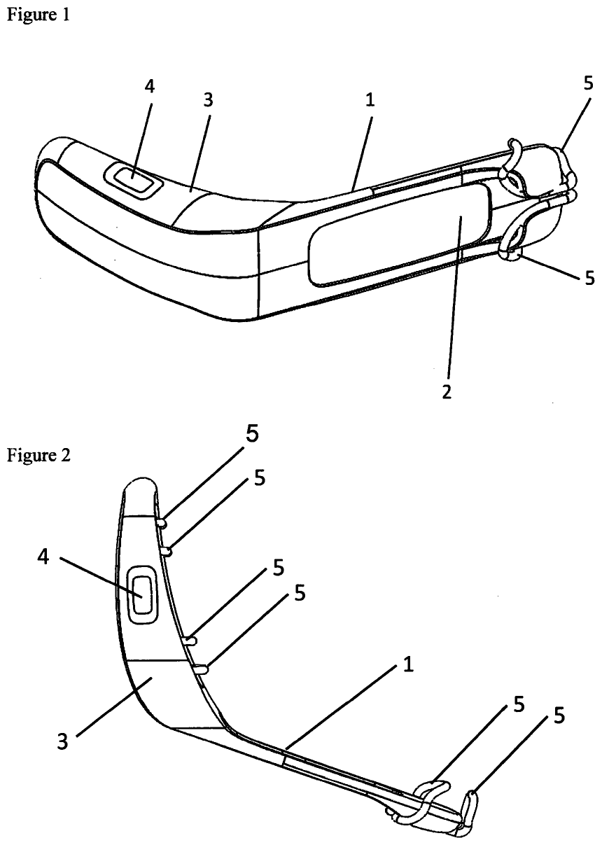

As shown in FIG. 1, the Heads-Up Display 1 comprises a mounting means 5 for releasably securing the Heads-Up Display 1 to a plurality of different shapes and sizes of eyewear items, such as swimming goggles. The Heads-Up Display 1 comprises a housing 3 that is watertight and sealed to prevent entry of water that would damage the components. The Heads-Up Display 1 incorporates a holographic display 2, that is configured to sit within the field of view of a wearer.

Inside the housing 3 are a processing unit, clock timer circuit, a micro display unit, at least one sensor and an optical wave guide, all of which are not shown, and are all configured to convey performance data in visual form into the field of view of the wearer, in focus, and without them having to alter their head position, whilst allowing them to still clearly view their surrounding environment.

The processing unit comprises a plurality of control means such as an on/off button or switch 6, a mode selection button, a download button and other control means that allow a wearer to control the Heads-Up Display both before, during and after an activity.

The mounting means 5 as shown comprises a plurality of O-rings that can be linked onto the nose bridge, strap or arm of the item of eyewear or goggles. This convenient form of releasably mounting the Heads-Up Display 1 to an item of eyewear ensures that it can be moved to an alternative item of eyewear should the need arise. The mounting means may also comprise clips, snap fits, cable tie ratchets and/or permanent mounting points with quick release fittings, not shown.

The processing unit is operatively connected to at least one sensor. This sensor may comprise an accelerometer, a pressure sensor, a heart rate sensor or a speed sensor. The processing unit may incorporate any combination of these according to the performance data that a wearer is required to track. The sensor obtains a data value or clock timer supplying data, the processing unit converts this data value to an image, this image is displayed on a micro display real-time, where the light travels through a collimating lens or other means to the holographic waveguide, so that what is visible on the micro display can be seen on the holographic display in the field of view and in focus for the wearer. The image can therefore appear on the holographic display instantaneously, allowing a wearer to view real-time performance data, presented within their field of view whilst they are undertaking a sporting activity.

The wearer can control what they see on the holographic display. Alternatively, the display can be controlled remotely by a coach or other professional, tracking the progress of the wearer.

The holographic display 2 comprises a transparent, retroreflective material that overlays the imagery of performance data onto the field of view of the wearer. The wave guide may incorporate one or more holographic couplers that control the path of the light through the wave guide.

The processing unit may incorporates a transceiver that is configured to enable downloading of the data to another device such as a smartphone, tablet or computer through BLUETOOTH® connectivity or other wireless means, for further data analysis and review. The Heads-Up Display 1 may be further enhanced with wireless connectivity to other existing swim watches or heart rate monitors or camera devices, such as GOPRO® or other systems.

The Heads-Up Display 1 may comprise a GPS tracking module that can allow directional data to be displayed on the holographic display 2. This is particularly useful for assistance when following a route map, such as for open water swimmers and triathletes or cross-country/adventurer runners. This could be displayed simply as a direction correction with arrow indicators or a more detailed display similar to car satellite navigation systems, with a map displaying position and progress.

The Heads-Up Display may incorporate a video camera or link to a separate device whereby the holographic display may be used to show the wearer a forward view without the necessity to look up. For an example, when swimming in open water or during a triathlon, it is imperative to view the direction of swim every 5 to 10 metres by spotting a landmark and correcting your swim direction. When doing this forward look, known as ‘crocodile eyes’, the swimmers body position is affected causing the hips and legs to lower creating a detrimental effect on the swim hydrodynamics. Being presented with a real-time view of what lies in front of the wearer, without the need to alter the head position, would prove most beneficial in such circumstances.

The Heads-Up Display may also incorporate a loud speaker whereby the device may signal the start or finish of a session audibly. Audio feed-back can also be used to reinforce training aspects such as stroke timing/rhythm.

FIG. 2 shows one arrangement of plurality of mounting means 5, which in this instance comprise a plurality of flexible O-Rings or elastic bands, that can be looped around the strap, arm or bridge piece, and hooked back onto a ridge or projection within the housing 3 of the Heads-Up Display 1. The Heads-Up Display 1 is designed such that the electronic components are mounted to the side of the wearer's head, with the holographic display 2 being presented around the front of the item of eyewear.

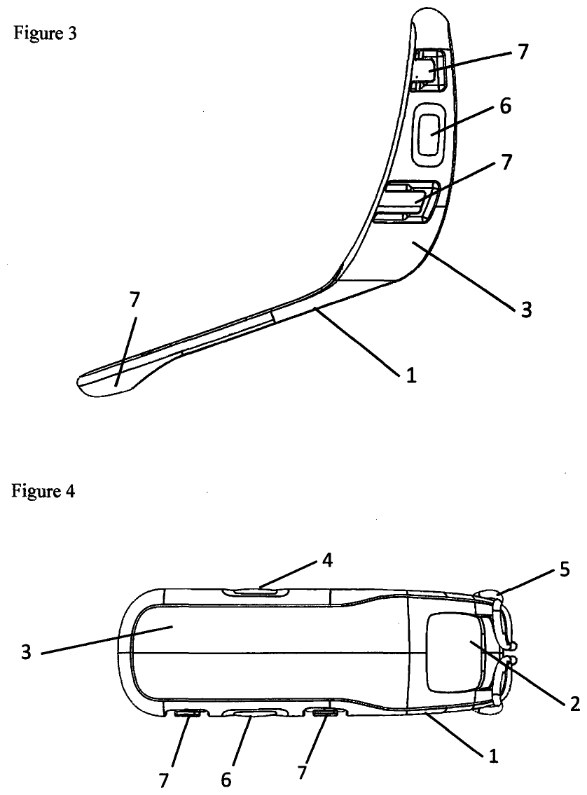

FIG. 3 shows a plurality of projections 7 configured to support the O-rings 5 once they have been wrapped about a part of the item of eyewear. The flexibility of the O-rings 5, or elastic bands, allows them to be easily and conveniently stretched and secured into place on the projection 7. A number of other mounting means 5 may be used, that allow the Heads-Up Display to be releasably secured to the eyewear item. These include but are not limited to clips, snap fits, cable tie ratchets and/or permanent mounting points with quick release fittings.

FIG. 4 shows the hydrodynamic profile of the Heads-Up Display 1, thus minimising drag to the wearer whilst participating in a particular activity. The control means 4 are flush with the body of the housing 3. The housing 3 comprises a sealed unit, ensuring a waterproof, watertight device suitable for submersion.

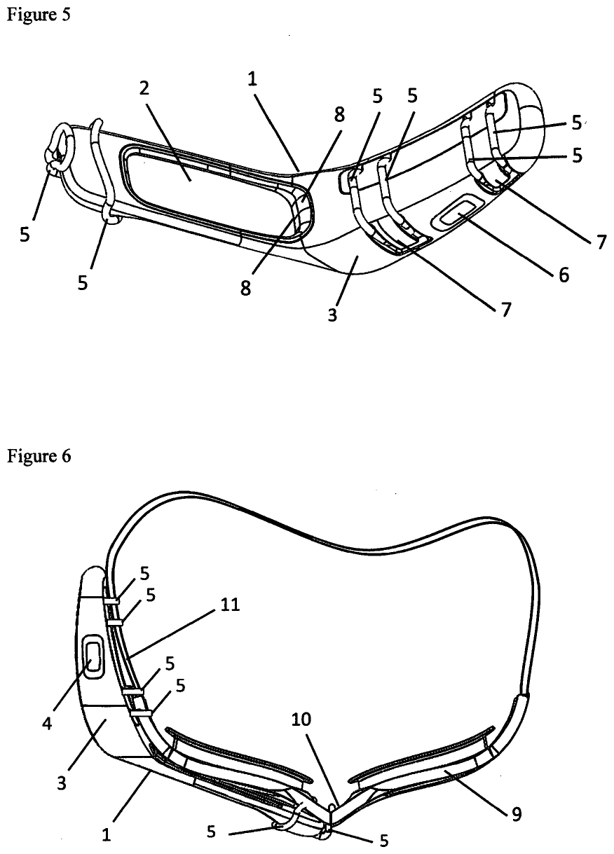

FIG. 5 shows the Heads-Up Display 1, showing the configuration of mounting means 5, comprising a plurality of O-rings and gripping means 7. FIG. 6 shows the Heads-Up Display 1 when mounted to a pair of swimming goggles 9 comprising a nose bridge 10 and strap 11. The mounting means 5 are wrapped and secured about the node bridge 10 and strap 11 and a plurality of locations to enable the Heads-Up Display 1 to be releasably secured.

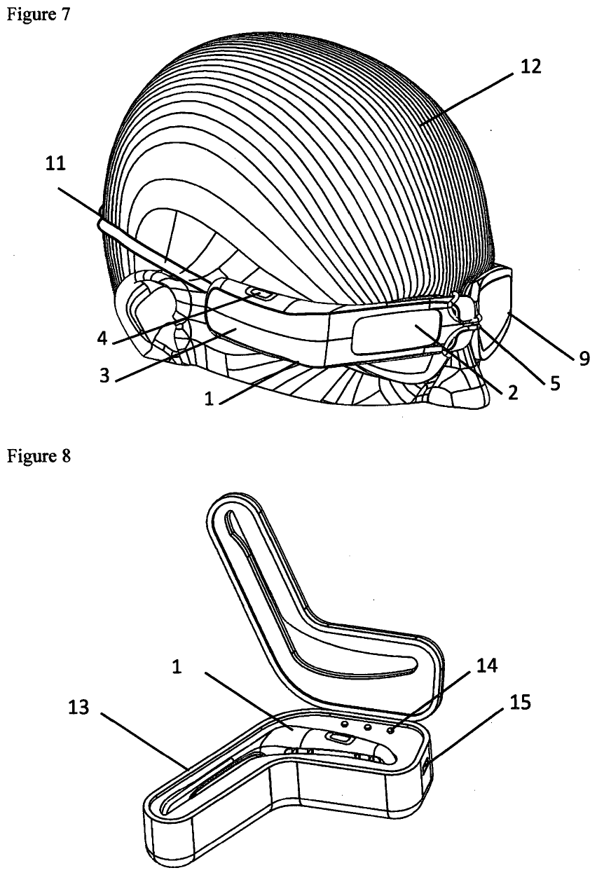

FIG. 7 shows the swimming goggles 9 with mounted Heads-Up Display 1 when arranged on a wearer's head 12. The holographic display 2 is shown presented in the field of view of the wearer, before one of the eye lenses of the swimming goggles 9. The control means 6 are located such that the wearer can easily access the buttons, before, during or after a sporting activity, without the need to remove the swimming goggles 9.

FIG. 8 shows one embodiment of charging case 13 with charging indicator 14. This charging case 13 uses contactless charging from an in built battery 14 within the case of the Heads-Up Display 1. The battery 14 within the charging case 13 has capacity for several swim sessions. This enables the battery within the Heads-Up Display 1 to be of minimal capacity and therefore this enables a compact and hydrodynamic package size. When the wearer loads the swimming goggles 9 and Heads-Up Display 1 into the charging case 13 the charging commences automatically. When the charging case 13 indicates a low capacity via the level indicator 14, the user may re-charge the charging case 13 directly from an electric source. This offers a level portability & flexibility for the swimmer.

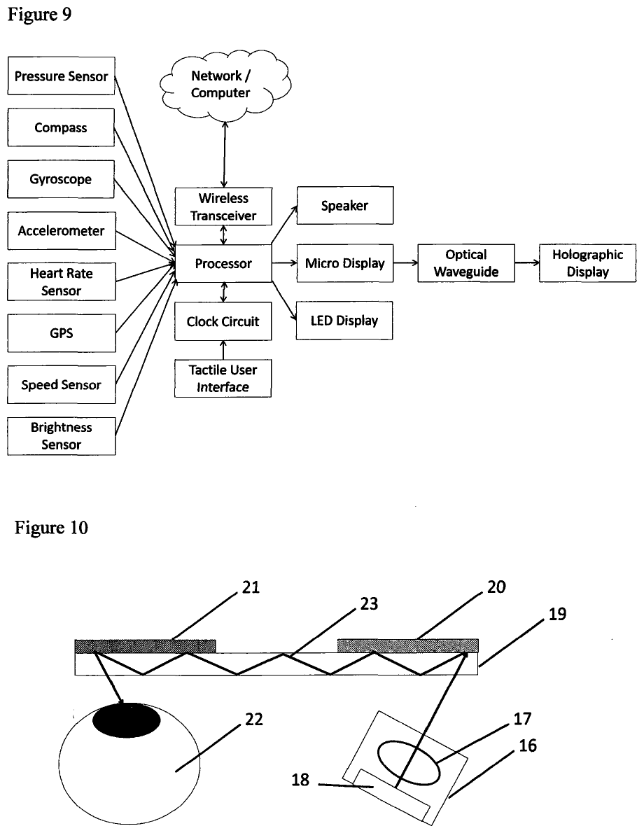

FIG. 9 shows a flow diagram of the Heads-Up Display 1, and the inputs and outputs to the display system. A plurality of sensors obtain data relating to performance, location, time and other parameters and feed this information into the processing unit. The processing unit may incorporate a wireless transceiver, that wirelessly communicates with a further device such as a computer, smartphone or tablet. The processor is either preloaded with required data, or loaded through wireless means, to provide the processor with comparative data, control means, coaching instructions and other information. The processor may also be operatively connected to a timing means, and may be controlled through a tactile user interface.

The processor is configured to obtain the performance data from the sensing means, and where necessary make a comparison with available performance data that has been preloaded or that is available through the wireless link, and generates an image relevant to the wearer from the performance data and the comparison made. This image is presented on the micro display, and relayed to a holographic display through an optical wave guide. The image may pass through a collimator lens prior to the optical wave guide, depending on focal length. The holographic display 2 is substantially transparent, allowing the wearer to view the surrounding environment through the holographic display 2 whilst also allowing the eye to view the image presented on the holographic display 2 at the same time. The image has been relayed from the processor instantaneously, allowing the wearer to view the relevant performance data at the time that the reading has been taken, or near enough. This allows the wearer to know their exact performance data at any given moment, and to alter their performance accordingly.

The wearer is also presented with a channel to have a display of training information and guidance, timing data for elapsed time, lap time and a comparison with past times, location, technique and other such information that can be relayed through an image within the field of view of the wearer.

FIG. 10 shows a diagrammatic view of the relationship of the image source on the micro display 18 to the wave guide 19 and holographic display 2. The wave guide 19 provides a means of routing the light rays from the micro display 18. An in holographic coupler 20, bonded through transparent adhesive means to the wave guide 19, introduces the light rays 23 that make up the image to the wave guide 19, where they are routed along this wave guide 19, until a further out holographic coupler 21 provides an exit for the light rays 23 that make up the image to pass out from the wave guide 19, and into the view of the human eye 22, providing an overlay to what the human eye 22 can currently see in their surroundings. The image rays 23 are total internally reflected along the wave guide 19. The image rays 23 created a virtual display of the image infront of the human eye 22, allowing for the image to be instantaneously changed to present new data, or constantly changing performance data values, before the human eye 22.

The wave guide 19 is arranged for guiding the image-bearing light to the transparent holographic display where the image can be displayed. The resulting image display gives an augmented reality display to the wearer. The collimator lens 17 is configured to channel and focus the image rays 23 from the micro display 18. The optical engine 16 supports the micro display 18 and collimator lens 17 in the correct configuration.

The Heads-Up Display 1 may be inbuilt within an item of eyewear, or a pair of swimming goggles, at least in part.

1. A heads-up display for an item of eyewear, the heads-up display comprising:
a mounting means configured to mount the heads-up display to the item of eyewear;
at least one sensor configured to obtain performance data;
a processing unit operatively connected to the at least one sensor, and configured to process said performance data and to generate an image from said performance data;
a micro display unit operatively connected to the processing unit, and configured to display the image under the control of the processing unit; and,
an optical wave guide in optical communication with the micro display unit, and configured to route the image from the micro display into a field of view of a wearer of the item of eyewear,
wherein the heads-up display is configured to overlay the image into the line of sight of the wearer, such that the wearer can view their surrounding environment at the same time as the image, and therefore view their performance data in real-time.

2. A heads-up display according to claim 1, wherein the optical wave guide is configured to route the image onto a holographic display.

3. A heads-up display according to claim 2, wherein the holographic display incorporates at least one holographic coupling element configured to couple the image within the waveguide.

4. A heads-up display according to claim 2, wherein the optical wave guide incorporates at least one hologram.

5. A heads-up display according to claim 1, wherein the at least one sensor comprises one or more of the following: accelerometer, pressure sensor, heart rate sensor, speed sensor.

6. A heads-up display according to claim 1, wherein the performance data comprises one or more of the following: time, speed, power, pace, heart rate, distance, acceleration, flow.

7. A heads-up display according to claim 1, wherein the processing unit incorporates control means comprising one or more of the following: on/off button, mode selection.

8. A heads-up display according to claim 1, wherein the mounting means comprises a plurality of O-rings.

9. A heads-up display according to claim 1, comprising a collimator lens configured to collimate the image, and mounted between the micro display unit and the optical wave guide.

10. A heads-up display according to claim 1, wherein the processing unit incorporates a transceiver to transmit and receive the performance data to and/or from a computer and/or smartphone and/or tablet device and/or video camera.

11. A heads-up display according to claim 10, wherein the transceiver comprises a short wavelength UHF radio module.

12. A heads-up display according to claim 1, wherein the processing unit incorporates a GPS module.

13. A heads-up display according to claim 1, wherein the processing unit incorporates a timing means.

14. A heads-up display according to claim 1, wherein the heads-up display incorporates a video camera.

15. A heads-up display according to claim 1, wherein the processing unit comprises a charging port, operatively connected to a rechargeable battery.

16. A contactless charging case for a heads-up display according to claim 1, wherein the heads-up display is charged through wireless means.

17. An item of eyewear incorporating the heads-up display of claim 1.

18. A pair of swimming goggles incorporating the heads-up display of claim 1.

19. (canceled)
